(19) United States
(12) Patent Application Publication
(10) Pub. No.: US 2020/0084321 A1
(43) Pub. Date: Mar. 12, 2020

(54) IMAGE PROCESSING SYSTEM, METHOD FOR CONTROLLING THE SAME, CONTROL PROGRAM THEREFOR, IMAGE PROCESSING APPARATUS, AND IMAGE DISPLAY APPARATUS

(71) Applicant: Konica Minolta Inc., Tokyo (JP)

(72) Inventors: Shiro UMEDA, Toyokawa-shi (JP); Masayuki WATANABE, Tokyo (JP); Takeshi ISHIDA, Toyohashi-shi (JP); Akinori KIMATA, Toyokawa-shi (JP); Takashi WATANABE, Toyokawa-shi (JP); Kouei CHO, Toyohashi-shi (JP)

(21) Appl. No.: 16/534,817

(22) Filed: Aug. 7, 2019

(30) Foreign Application Priority Data
Sep. 7, 2018 (JP) 2018-167930

(51) Int. Cl. H04N 1/00

(52) U.S. Cl. CPC H04N 1/00058; H04N 1/00244; H04N 1/00037; H04N 1/00408; H04N 1/00307

(57) ABSTRACT

An image processing system includes: a mobile terminal; and a server apparatus, wherein the mobile terminal includes a camera, a display that displays an apparatus image of an image forming apparatus, a microphone that collects sound output from the image forming apparatus, and a first hardware processor that controls the camera, the microphone and the display, the server apparatus includes a second hardware processor that controls the server apparatus, the second hardware processor performs identifying a portion of the image forming apparatus, setting the portion identified as a sound collection target position, and clipping a partial image including the sound collection target position and representing an outline of a part of the image forming apparatus, from a main body image generated in advance as an image representing an outer shape of the image forming apparatus, and the display displays the partial image.

The entire disclosure of Japanese patent Application No. 2018-167930, filed on Sep. 7, 2018, is incorporated herein by reference in its entirety.

### BACKGROUND

### Technological Field

The present disclosure relates to an image processing system, and more particularly to collecting of sound output from an image forming apparatus.

### Description of the Related Art

Conventionally, there have been cases where it is difficult to identify a cause of a failure such as printing disabled occurs with abnormal sound that is not output during normal printing is output from the inside of an image forming apparatus. In this context, for example, in JP 2017-111293 discloses a technique of “acquiring sound produced and analyzing a cause of the sound with the sound acquired at an appropriate position depending on characteristics of each model of an apparatus that is a target of the sound acquisition” (see Abstract).

According to the technology disclosed in JP 2017-111293, the mobile terminal is moved to a predetermined reference position based on an image displayed on a display of a mobile terminal. Then, the mobile terminal needs to be moved toward a position at which sound output from an image forming apparatus is acquired, by referring to an image displayed on the display and the like. More specifically, in order to acquire the sound output from the image forming apparatus, the mobile terminal is moved to the reference position near the image forming apparatus, and then, based on an instruction image that is an arrow displayed on the display of the mobile terminal, the mobile terminal needs to be moved to the appropriate position away from the image forming apparatus. Thus, it takes time to acquire the sound output from the image forming apparatus. Furthermore, it is difficult for the user to intuitively recognize the appropriate position. In view of this, a technique for making it easy to intuitively recognize the appropriate position at which sound to be output from the image forming apparatus has been called for.

### SUMMARY

The present disclosure has been made in view of the condition described above, and a technique is disclosed that enables a position at which sound output from an image forming apparatus is collected to be easily and intuitively recognized.

To achieve the abovementioned object, according to an aspect of the present invention, an image processing system reflecting one aspect of the present invention comprises: a mobile terminal; and a server apparatus that communicates with the mobile terminal, wherein the mobile terminal includes a camera, a display that displays an apparatus image of an image forming apparatus forming an image, based on a signal acquired by the camera, a microphone that collects sound output from the image forming apparatus, and a first hardware processor that controls the camera, the microphone and the display, the server apparatus includes a second hardware processor that controls the server apparatus, the second hardware processor performs by acquiring information input to the mobile terminal, identifying a portion of the image forming apparatus through which sound produced in the image forming apparatus passes to be output to outside, setting the portion identified as a sound collection target position at which sound is collected with the microphone, and clipping a partial image including the sound collection target position and representing an outline of a part of the image forming apparatus, from a main body image generated in advance as an image representing an outer shape of the image forming apparatus, and the display displays the partial image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an image processing system according to the present embodiment;

FIG. 2 is a diagram illustrating an example of an overall configuration of an image forming apparatus according to the present embodiment;

FIG. 3 is a block diagram illustrating a main hardware configuration of image forming apparatus according to the present embodiment;

FIG. 4 is a block diagram illustrating a main hardware configuration of a mobile terminal according to the present embodiment;

FIG. 5 is a block diagram illustrating a main hardware configuration of a server apparatus according to the present embodiment;

FIG. 6 is a diagram illustrating the positions of a camera and a microphone of the mobile terminal according to the present embodiment;

FIG. 7 is a diagram schematically illustrating processing of clipping a partial image according to the present embodiment;

FIG. 8 is a diagram illustrating an example of a screen for inputting information such as an abnormal sound produced position and the like according to the present embodiment;

FIG. 9 is a diagram illustrating a side surface of the image forming apparatus for describing processing of identifying a sound passage position on the main body of the image forming apparatus and processing of setting a sound collection target position according to the present embodiment,

FIG. 10 is a diagram illustrating an upper surface of the image forming apparatus for describing the processing of identifying a sound passage position on the main body of the image forming apparatus and the processing of setting the sound collection target position according to the present embodiment;

FIG. 11 is a diagram illustrating how a partial image and art apparatus image are overlapped according to time present embodiment;

FIG. 12 is a flowchart illustrating a structure of control performed in the image forming apparatus, the mobile terminal, and the server apparatus according to the present embodiment;

FIG. 13 is a flowchart illustrating a structure of control performed in the image forming apparatus, the mobile terminal, and the server apparatus according to the present embodiment;

FIG. 14 is a flowchart illustrating a structure of control performed in the image forming apparatus, the mobile terminal, and the server apparatus according to the present embodiment;

FIG. 15 is a flowchart illustrating a structure of control performed in the image forming apparatus, the mobile terminal, and the server apparatus according to the second embodiment;

FIG. 16 is a diagram illustrating how sensitivity of the microphone is changed in response to a change in the size of the apparatus image according to the present embodiment;

FIG. 17 is a diagram illustrating how a partial image, clipped from a main body image, is displayed in a display area of a display of the mobile terminal according to the present embodiment; and

FIG. 18 illustrates a state of the image forming apparatus according to the present embodiment with a front door and a side door open.

### DETAILED DESCRIPTION OF EMBODIMENTS

Hereinafter, one or more embodiments of the present invention will be described with reference to the drawings. However, the scope of the invention is not limited to the disclosed embodiments. Their names and functions are also the same. Therefore, detailed description thereof will not be repeated.

### First Embodiment

[Configuration of Image Processing System 1]

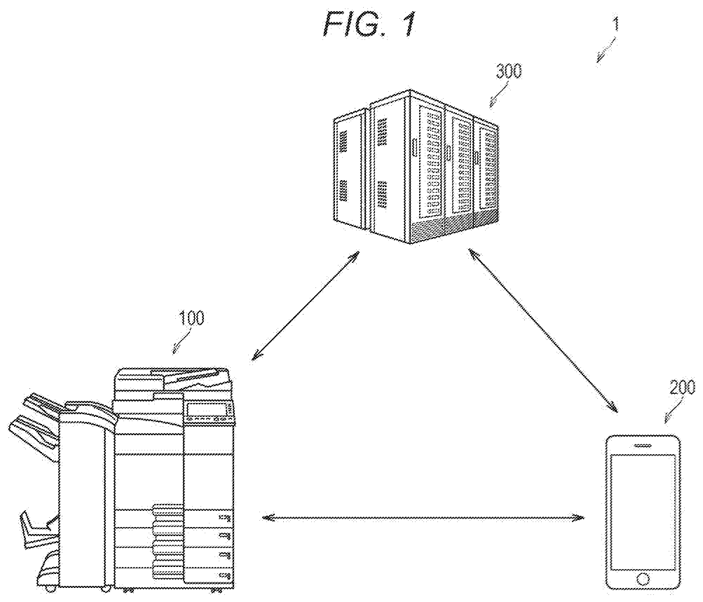

FIG. 1 is a diagram schematically illustrating an image processing system 1 according to the present embodiment. Referring to FIG. 1, the image processing system 1 includes an image forming apparatus 100, a mobile terminal 200, and a server apparatus 300. The image forming apparatus 100, the mobile terminal 200, and the server apparatus 300 communicate with each other. The communications between image forming apparatus 100 and mobile terminal 200 are implemented by, for example, short range wireless communications. The short range wireless communications may be, for example, Near field communication (NFC) (registered trademark), Bluetooth (registered trademark) communication, Wireless Fidelity (WiFi) (registered trademark) communication, or the like. The communications between the image forming apparatus 100 and the server apparatus 300 includes, for example, communications via a public network such as the Internet, a public line, or a public wireless Local Area Network (LAN). The communications between the mobile terminal 200 and the server apparatus 300 includes, for example, communications via a public network such as the Internet, a public line, or a public wireless LAN.

[Configuration of Image Forming Apparatus 100]

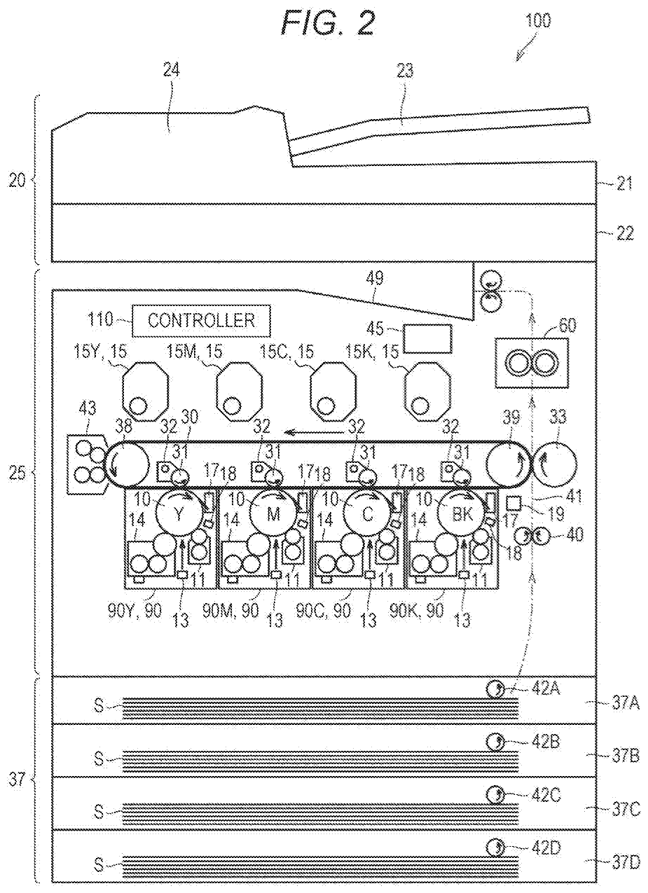

FIG. 2 is a diagram illustrating an example of an overall configuration of the image forming apparatus 100 according to the present embodiment. Hereinafter, the image forming apparatus 100 will be described as a color printer, but is not limited to the color printer. For example, the image forming apparatus 100 may be a monochrome printer, or may be a multi functional peripheral (MFP) which is a combination of a monochrome printer or a color printer and a facsimile.

Referring to FIG. 2, the image forming apparatus 100 includes a scanner unit 20 serving as an image reader, an image forming unit 25, and a sheet feed unit 37. The sheet feed unit 37 includes, for example, a first sheet feed unit 37A, a second sheet feed unit 37B, a third sheet feed unit 37C, and a fourth sheet feed unit 37D. In the following description, the sheet feed unit 37 includes the four units. However, the number of units is not limited to four and may be any number not smaller than one. The sheet feed unit 37 is a tray in which sheets S are set. The sheet feed unit 37 is configured to be detachable from the image forming apparatus 100. A user can set the sheets S in the sheet feed unit 37 by taking out the sheet feed unit 37 from the image forming apparatus 100. The size and type of sheets S to be stored may be different or the same among the first sheet feed unit 37A to the fourth sheet feed unit 37D. Opening and closing of the sheet feed unit 37 is detected by an opening and closing sensor (not illustrated). In the following description, the user includes the user of the image forming apparatus 100 and the service person from the manufacturer of the image forming apparatus 100.

Sheet feed rollers 42A, 42B, 42C, and 42D are each connected to a motor (not illustrated) via a clutch (not illustrated). The sheet feed rollers 42A to 42D may be collectively referred to as a sheet feed roller 42. When the motor is driven, the sheet feed roller 42 rotates to send the sheets from the sheet feed unit 37 to a sheet conveyance path 41 one by one.

The sheet feed roller 42 is made of rubber for example. More specifically, the sheet feed roller 42 has an outer circumference portion made of ethylene propylene rubber or urethane rubber. As the number of sheets sent by the sheet feed roller 42 increases, the rubber of the sheet feed roller 42 wears. This may result in occurrence of abnormal sound not produced when the sheet S is sent during normal printing, or a fractional coefficient lowered to be insufficient for the conveyance of the sheet S to the sheet conveyance path 41. Thus, the sheet feed roller 42 is a consumable part. The sheet feed roller 42 is, for example, recommended to be exchanged when the number of printed sheets reaches 300,000.

The scanner unit 20 includes a cover 21, a platen 22, a tray 23, and an auto document feeder (ADF) 24. The cover 21 has one end fixed to the platen 22, to be capable of pivoting about this one end to he opened and closed.

The user of the image forming apparatus 100 can set a document on the platen 22 by opening the cover 21. Upon receiving a scan instruction in a state where the document is set on the platen 22, the image forming apparatus 100 starts scanning the document set on the platen 22. Further, when the image forming apparatus 100 receives a scan instruction in a state where the document is set on the tray 23, the ADE 24 automatically conveys the documents one by one.

The image forming unit 25 includes an image processing part 45, an image forming part 90, a toner bottle 15, an image density control (IDC) sensor 19, a transfer belt 30, a primary transfer roller 31, a transfer drive 32, a secondary transfer roller 33, a driven roller 38, a driving roller 39, a timing roller 40, a cleaning unit 43, a fixing unit 60, and a controller 110 are provided.

The image processing part 45 executes predetermined image processing on image data read by the scanner unit 20. The image processing part 45 includes a circuit that performs digital image processing on the image data. The image processing part 45 executes various types of correction processing on the image data. Examples of this processing include gradation correction, color correction, shading correction, and compression processing. The image forming part 90 forms an image based on the image data as a result of the processing.

The image forming part 90 includes image forming parts 90Y, 90M, 90C, and 90K. The toner bottle 15 includes toner bottles 15Y, 15M, 15C, and 15K. The image forming parts 90Y, 90M, 90C, and 90K are arranged along the transfer belt 30, in this order along a rotation direction of the transfer belt 30. The image forming part 90Y, to which toner is supplied from the toner bottle 15Y, forms a yellow (Y) toner image. The image forming part 90M, to which toner is supplied from the toner bottle 15M, forms a magenta (M) toner image. The image forming part 90C, to which toner is supplied from the toner bottle 15C, forms a cyan (C) toner image. The image forming part 90K, to which toner is supplied from the toner bottle 15K, forms a black (BK) toner image.

The image forming parts 90Y, 90M, 90C, and 90K each include a photosensitive member 10 configured to be rotatable, a charger 11, an exposure device 13, a developer 14, a cleaning blade 17, and a toner sensor 18. After the image forming parts 90Y, 90M, 90C, and 90K have operated as described above, the transfer drive 32 transfers the toner images of yellow (Y), magenta (M), cyan (C), and black (BK) from the photosensitive members 10 to the transfer belt 30 in an overlapping manner. Thus, a color toner image (not illustrated) is formed on the transfer belt 30.

The IDC sensor 19 detects the density (toner amount) of the toner image formed on the transfer belt 30. For example, the IDC sensor 19 is a light intensity sensor including a reflective photo sensor, and detects the intensity of light reflected from a surface of the transfer belt 30.

The transfer belt 30 is stretched between the driven roller 38 and the driving roller 39. The driving roller 39 is connected to a motor (not illustrated). This motor is controlled by the controller 110 described later. The driving roller 39 is rotated, with the motor controlled. The transfer belt 30 and the driven roller 38 rotate are rotationally driven by the driving roller 39. Thus, the toner image on the transfer belt 30 is sent to the secondary transfer roller 33.

The tinting roller 40 conveys the sheet S, conveyed from the sheet feed mat 37 to the sheet conveyance path 41 by the sheet feed roller 42, to the secondary transfer roller 33,

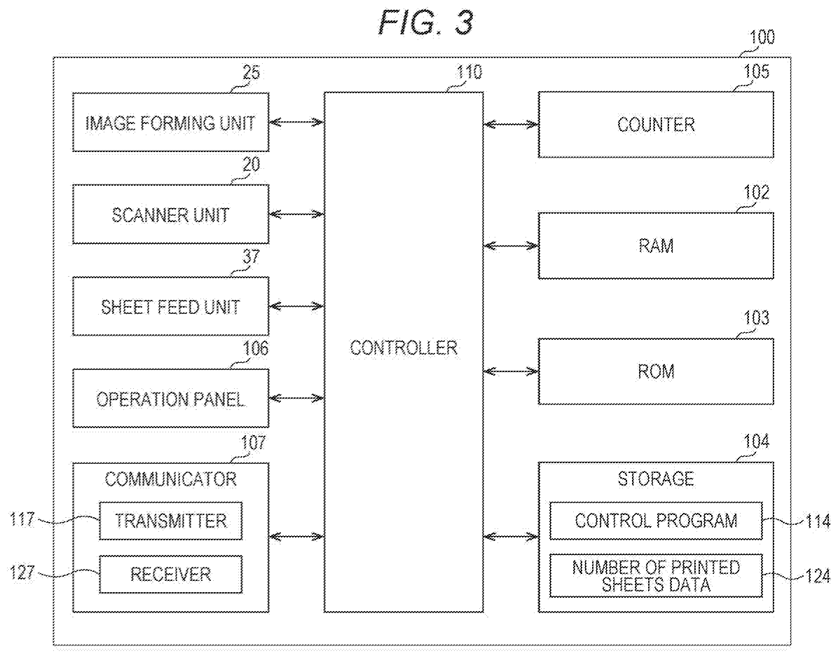

Upon receiving a printing start instruction, the controller 110 executes the printing by controlling transfer voltage applied to the secondary transfer roller 33 based on a timing at which the sheet is fed. The controller 110 receives the printing start instruction in response to an operation on an operation panel (an operation panel 106 illustrated in FIG. 3 and described later) by the user of the image forming apparatus 100.

The secondary transfer roller 33 applies transfer voltage, having a polarity opposite to that of the charge polarity of the toner image, to the sheet being conveyed. As a result, the toner image is attracted from the transfer belt 30 to the secondary transfer roller 33. In this manner, the toner image on the transfer belt 30 is transferred. The timing at which the sheet is conveyed to the secondary transfer roller 33 is controlled by the timing roller 40, based on the position of the toner image on the transfer belt 30. As a result, the toner image on the transfer belt 30 is transferred onto an appropriate position on the sheet.

The fixing unit 60 heats and presses the sheet passing through the fixing unit 60. Thus, the toner image is fixed to the sheet. Thereafter, the sheet is discharged onto a tray 49.

The cleaning unit 43 collects the toner remaining on the surface of the transfer belt 30 after the toner image has been transferred onto the sheet S from the transfer belt 30. The collected toner is conveyed by a conveyance screw (not illustrated) to be stored in a waste toner container (not illustrated).

The components of the image forming apparatus 100 include consumable parts such as the above-described sheet feed roller 42. For example, when the consumable parts are used over their recommended exchanging timings, abnormal sound that does not occur dining normal printing occurs. Such abnormal sound may be output from the inside of the image forming apparatus 100 to the outside. The exchange timing is determined, for example, by the number sheets printed by the image forming apparatus 100. The number of sheets indicating the timing varies among the consumable parts. Examples of the consumable parts and the number of printed sheets indicating their exchanging timing are as follows: the photosensitive member 10 (for example, 400,000 sheets), the developer 14 (for example, 1.2 million sheets), and the fixing unit 60 (for example, 1.6 million sheets).

[Hardware Configuration of Image Forming Apparatus 100]

FIG. 3 is a block diagram illustrating a main hardware configuration of image forming apparatus 100 according to the present embodiment. An example of the hardware configuration of the image forming apparatus 100 will be described with reference to FIG. 3. The image forming apparatus 100 includes a scanner unit 20, an image forming unit 25, a sheet feed unit 37, a random access memory (RAM) 102, a read only memory (ROM) 103, a storage 104, a counter 105, an operation panel 106, a communicator 107, and a controller 110.

The RAM 102 is implemented with a dynamic RAM (DRAM) or the like. The RAM 102 temporarily stores data necessary for the controller 110 to operate a program and image data. The RAM 102 functions as what is known as a working memory.

The ROM 103 is realized with a flash memory or the like. The ROM 103 stores programs executed by the controller 110 and various setting information related to the operation of the image forming apparatus 100.

The storage 104 is, for example, a hard disk, a solid state drive (SSD), or another type of storage. The storage 104 may be an internal or an external storage. The storage 104 stores a control program 114 for controlling print processing executed by the image forming apparatus 100. The storage 104 also stores number of printed sheets data 124 including the number of printed sheets counted by the counter 105. The number of printed sheets is the total number of printed sheets S minted by the image forming apparatus 100.

The counter 105 counts the number of printed sheets S. The counter 105 counts, for example, the number of sheets S discharged onto the tray 49.

The operation panel 106 includes a display and a touch panel. The display and the touch panel are overlapped with each other, and receive a touch operation corresponding to an operation on the image forming apparatus 100. As an example, the operation panel 106 receives an operation for print settings including selection of the size of the sheet S, an operation for initiating printing, and the like. The operation panel 106 notifies the user of information indicating that the exchanging timing of consumable parts is near, based on the number of printed sheets counted by the counter 105. The notification to the user may be issued as audio information output from a speaker (not illustrated) provided to the image forming apparatus 100, as well as information provided, using characters displayed on the operation panel 106.

The communicator 107 includes a transmitter 117 for transmitting data to an external apparatus, and a receiver 127 for receiving data from the external apparatus. The communicator 107 transmits and receives various types of data to and from the mobile terminal 200 and the server apparatus 300.

The controller 110 controls the components of the scanner unit 20, the image forming unit 25, and the sheet feed unit 37 included in the image forming apparatus 100. For example, the controller 110 includes at least one integrated circuit. The integrated circuit is, for example, at least one central processing Unit (CPU), at least one application spec integrated circuit (ASIC), at least one field programmable gate array (FPGA), or a combination of these.

The controller 110 starts printing upon receiving the printing start instruction, in response to the user operating the operation panel 106. The controller 110 also starts the printing upon receiving the printing start instruction in response to the user operating the mobile terminal 200, instead of operating the operation panel 106 of the image forming apparatus 100.

[Hardware Configuration of Mobile Terminal 200]

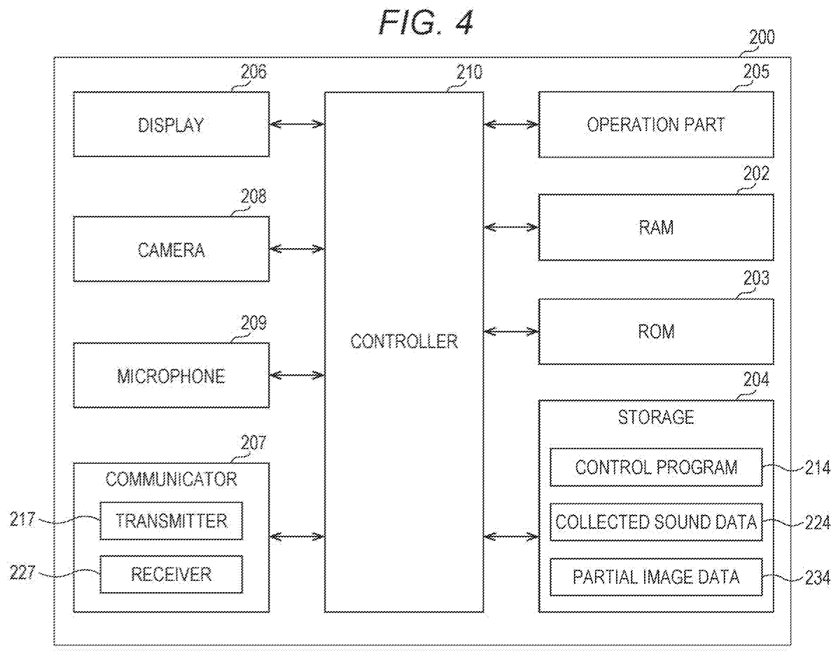

FIG. 4 is a block diagram illustrating a main hardware configuration of the mobile terminal 200 according to the present embodiment. The mobile terminal 200 is, for example, a terminal owned by a user in charge of the maintenance of the image forming apparatus 100. The mobile terminal 200 is described as a smart phone in the following example, but is not limited to a smart phone. For example, the mobile terminal 200 may be a tablet terminal, a laptop personal computer (PC), a digital camera, an electronic dictionary, a personal digital assistant (PDA), or the like.

An example of the hardware configuration of the mobile terminal 200 will be described with reference to FIG. 4. The mobile terminal 200 includes a RAM 202, a ROM 203, a storage 204, an operation part 205, a display 206, a communicator 207, a camera 208, a microphone 209, and a controller 210.

The RAM 202 is implemented with a DRAM or the like. The RAM 202 temporarily stores various types of data necessary for the controller 210 to operate a program. The RAM 202 functions as a what is known as a working memory.

The ROM 203 is implemented with a flash memory or the like. The ROM 203 stores programs executed by the controller 210 and various types of setting information related to the operation of the mobile terminal 200.

The storage 204 is, for example, a hard disk, an SSD, or other types of storage. The storage 204 may be an internal or external storage. The storage 204 stores a control program 214 for controlling various types of processing executed by the mobile terminal 200.

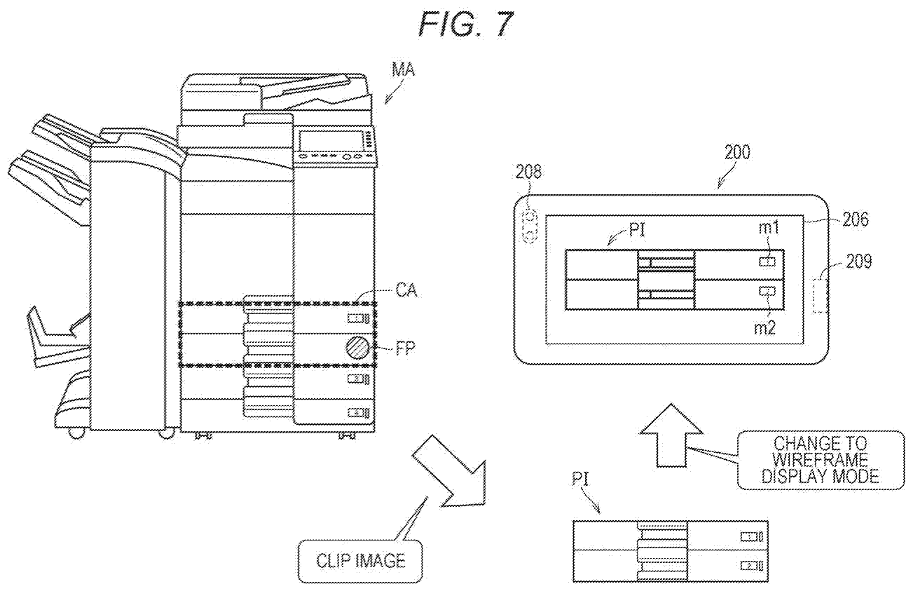

The storage 204 further stores collected sound data 224 and partial image data 234. The collected sound data 224 corresponds to sound output from the inside of the image forming apparatus 100 to the outside and collected and stored with the microphone 209. The partial image data 234 is data transmitted from the server apparatus 300. More specifically, the partial image data 234 is data including a partial image (for example, “partial image PI” illustrated in FIG. 7 described later) representing an outline of a part of the image forming apparatus 100. The part of the image forming apparatus 100 is, for example, any one of the scanner unit 20, the image forming unit 25, and the sheet feed unit 37. The partial image PI is an image clipped from a main body image (for example, a “main body image MA” illustrated in FIG. 7 described later) representing the outer shape of image forming apparatus 100.

The operation part 205 receives a user operation. The operation part 205 is an input apparatus which is at least one of a mechanical switch and a touch panel.

The display 206 is, for example, a liquid crystal display, an organic electro luminescence (EL) display, or another type of display apparatus. As an example, the display 206 overlaps with the touch panel, and serves as the operation part 205 to receive an instruction when the touch panel is operated by the user. The display 206 displays an image of the image forming apparatus 100 (hereinafter, also referred to as “apparatus image”) based on a signal acquired by the camera 208.

The communicator 207 includes a transmitter 217 for transmitting data to an external apparatus, and a receiver 227 for receiving data from the external apparatus. The communicator 207 transmits and receives various types of data to and from the image forming apparatus 100 and the server apparatus 300.

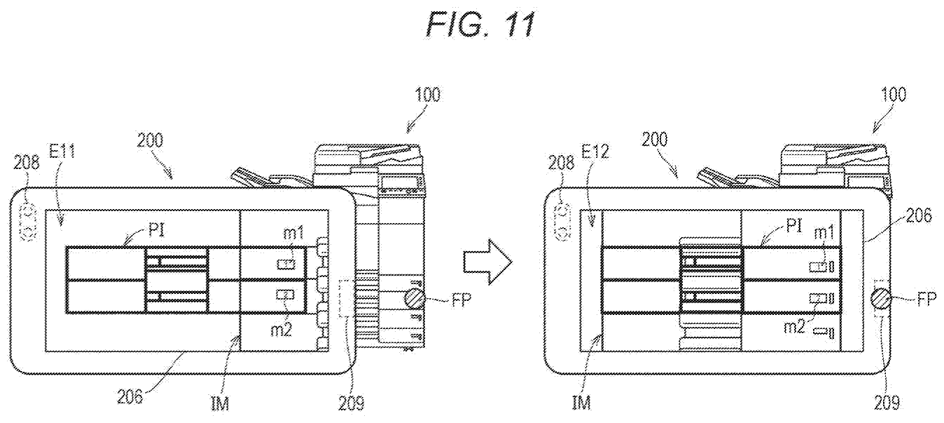

The camera 208 captures an image of an object based on a user operation and generates image data representing the object. Also, the image of the subject acquired by the camera 208 before the image capturing is displayed on the display 206 as a preview image. For example, an apparatus image (for example, an “apparatus image IM” illustrated in FIG. 11 described later) acquired by the camera 208 is displayed on the display 206.

The microphone 209 collects sounds around the mobile terminal 200. For example, the microphone 209 can collect sound output from the inside of the image forming apparatus 100 under a certain situation.

The controller 210 includes at least one integrated circuit for example. The integrated circuit is, for example, at least one CPU, at least one ASIC, at least one FPGA, or a combination thereof. The controller 210 receives an input from the user operating the mobile terminal 200 in which a preinstalled application has been started. This input includes a produced position of abnormal sound output from the image forming apparatus 100. This input information related to sound, including the information about the abnormal sound produced position and the like input from the mobile terminal 200 (hereinafter, also referred to as “input information), is transmitted from the transmitter 217 of the controller 210 to the server apparatus 300.

Furthermore, the controller 210 causes the display 206 to display the partial image P1 received from the server apparatus 300 by the receiver 227 and the apparatus image IM based on the signal acquired by the camera 208. When the apparatus image IM displayed on the display 206 matches the partial image PI as a result of a movement of the user holding the mobile terminal 200, the controller 210 starts collecting the sound using the microphone 209, and transmits the resultant sound to the server apparatus 300 using the transmitter 217.

[Hardware Configuration of Server Apparatus 300]

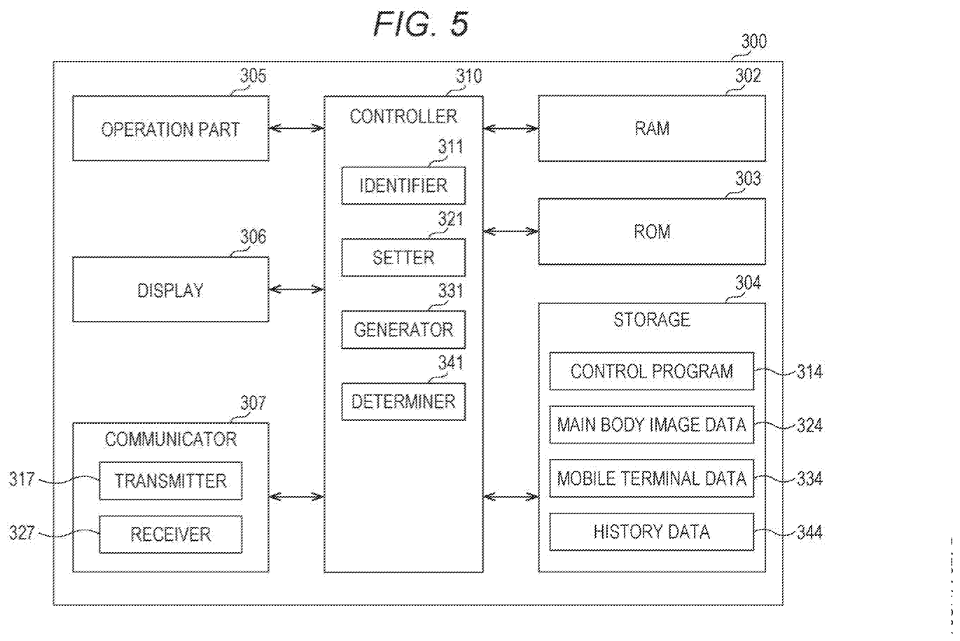

An example of the configuration of the server apparatus 300 will be described with reference to FIG. 5. FIG. 5 is a block diagram illustrating a main hardware configuration of the server apparatus 300 according to the present embodiment. The server apparatus 300 manages the image forming apparatus 100. The server apparatus 300 includes a RAM 302, a ROM 303, a storage 304, an operation pail 305, a display 306, a communicator 307, and a controller 310,

The RAM 302 is implemented with a DRAM or the like. The RAM 302 temporarily stores various types of data necessary for the controller 310 to operate a program. The RAM 302 functions as what is known as a working memory.

The ROM 303 is implemented with a flash memory or the like. The ROM 303 stores programs executed by the controller 310 and various types of setting information related to the operation of the server apparatus 300.

The storage 304 is, for example, a hard disk, an SSD, or other types of storage. The storage 304 may be an internal or external storage. The storage 304 stores a control program 314 for controlling, various types of processing (for example, processing of clipping the partial image PI) executed by the server apparatus 300. The storage 304 stores main body image data 324 used for the controller 310 to clip the partial image PI.

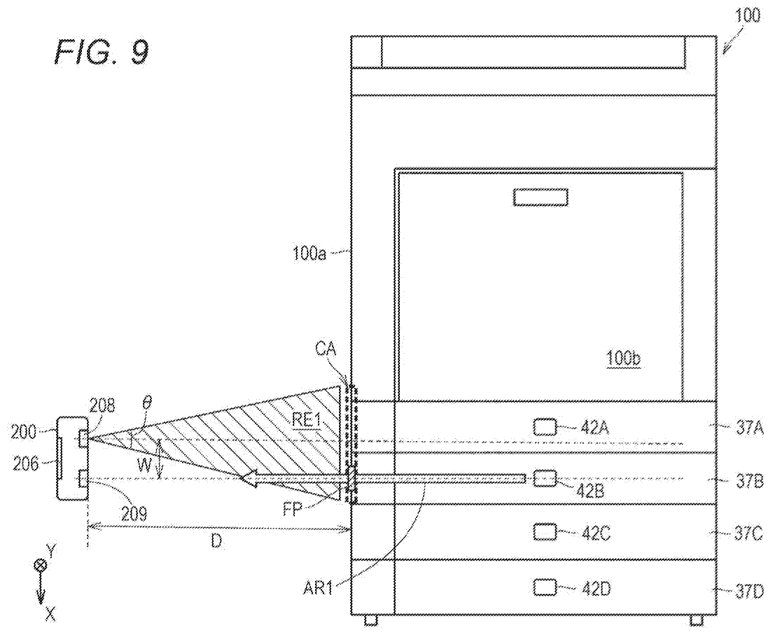

The main body image data 324 is an image representing the outer shape of the image forming apparatus 100, and is an image generated in advance. Since the outer shape of the image forming apparatus 100 varies among models, the main body image data 324 includes image data for each model of the image forming apparatus 100. The main body image data 324 may be data of a two-dimensional image or data of a three-dimensional image. The main body image data 324 that is data of a two-dimensional image at least includes image data of the front surface (a front surface 100a illustrated in FIG. 9 described later) and a side surface (side surface 100b illustrated in FIG. 9 described later) of the image forming apparatus 100.

The storage 304 further stores mobile terminal data 334 and history data 344. The mobile terminal data 334 includes the angle of view of the camera 208 of the mobile terminal 200 and the positions of the camera 208 and the microphone 209. The history data 344 is associated with the model number of the image forming apparatus 100. The history data 344 further includes the cause and the date and time of sound produced in the past, the name of the consumable part exchanged (such as the sheet feed roller, the photosensitive member, or the like), and the number of printed sheets indicating the exchanging timing.

[Description on Positions of Camera 208 and Microphone 209 of Mobile Terminal 200]

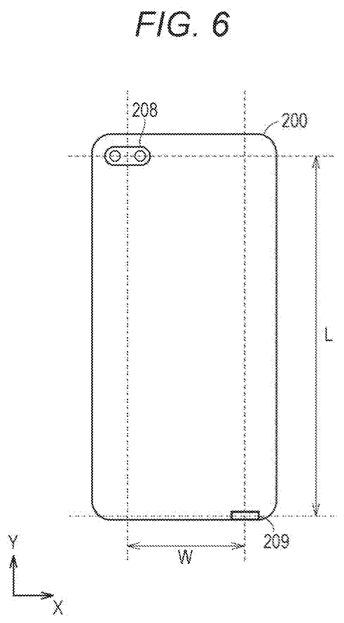

The positions of the camera 208 and the microphone 209, included in the mobile terminal data, will be described with reference to FIG. 6. FIG. 6 is a diagram illustrating the positions of the camera 208 and the microphone 209 of the mobile terminal 200 according to the present embodiment. In FIG. 6, an XY orthogonal coordinate system is used. The directions of the X axis and the Y axis of the orthogonal coordinate system respectively correspond to the width and the length directions of the mobile terminal 200. The camera 208 of the mobile terminal 200 is provided near one of the four corners (portions corresponding to the corners of the rectangular main surface) of the main body of the mobile terminal 200. Furthermore, the microphone 209 is provided near another one of the four corners. The microphone 209 is positioned to be separated from the camera 208 by a distance W the width direction (X axis direction) and by a distance L the length direction (Y axis direction).

The positions of the camera 208 and the microphone 209 differ among models of the mobile terminal 200. Furthermore, the angle of view of the camera 208 also differs among the models of the mobile terminal 200. The storage 304 stores the mobile terminal data 334. The mobile terminal data 334 includes an angle of view θ of each model of the mobile terminal 200. The mobile terminal data 334 also includes the position of the camera 208 and the position of the microphone 209. The above description on the X axis and the Y axis is applied to the context involving the orthogonal coordinate system in the following description on the mobile terminal 200.

The controller 310 includes at least one integrated circuit for example. The integrated circuit is, for example, at least one CRU, at least one ASIC, at least one FPGA, or a combination thereof.

Referring back to FIG. 5, the operation part 305 is an input device such as a keyboard and a mouse, for example.

The display 306 is, for example, a liquid crystal display, an organic EL display, or another type of display apparatus that displays results of the processing executed by the controller 310 and the like.

The communicator 307 includes a transmitter 317 for transmitting data to an external apparatus, and a receiver 327 for receiving data from the external apparatus. The communicator 307 transmits and receives various types of data to and from the image forming apparatus 100 and the mobile terminal 200.

The controller 310 has a function to serve as an identifier 311 that identifies a portion on the image forming apparatus 100, based, on the input information transmitted from the transmitter 117 of the mobile terminal 200. The sound produced inside the image forming apparatus 100 passes through a portion of the image forming apparatus 100 to be output to the outside.

The controller 310 has a function to serve as a setter 321 that sets the identified portion of the image forming apparatus 100, as a sound collection target position at which sound is collected with the microphone 209 of the mobile terminal 200. Furthermore, the controller 310 has a function to serve as a generator 331 that clips the partial image PI representing the outline of a part of the image forming apparatus 100, from the main body image MA and including the sound collection target position. The main body image MA, which is an image representing the outer shape of the image forming apparatus 100, is included in the main body image data 324 generated in advance and stored in the storage 304.

The controller 310 has a function to serve as an analyzer 341 that analyzes the frequency, the amplitude, and the like included in the sound collected with the microphone 209 of the mobile terminal 200. A result of the analysis performed by the controller 310 is transmitted from the transmitter 317 to the mobile terminal 200, in the following, processing of clipping the partial image PI executed by the controller 310 serving as the generator 331 is described, and then processing of identifying a sound passage position executed by the controller 310 serving as the identifier 311 and processing of setting the sound collection target position executed by the controller 310 sewing as the setter 321 are described.

[Processing of Clipping Partial Image PI]

FIG. 7 is a diagram schematically illustrating the processing of clipping the partial image PI according to the present embodiment. Referring to FIG. 7, the controller 310 reads the main body image MA included in main body image data 324 stored in the storage 304. More specifically, the controller 310 reads the main body image MA corresponding to the model of image forming apparatus 100. The model of the image forming apparatus 100 is included in the input information transmitted from the mobile terminal 200. The main body image MA illustrated in FIG. 7 is an image corresponding to the model of the image forming apparatus 100.

The controller 310 clips the partial image PI from a partial area of the main body image MA. More specifically, the controller 310 clips an image included in a clipping area CA including the sound collection target position FP from the main body image MA, as the partial image PI. The sound collection target position FP is a position to be a target of the sound collection by the microphone 209 of the mobile terminal 200. The processing of setting the sound collection target position FP will be described later. The clipping area CA is an area set based on the outline of a part (the sheet feed unit 37 for example) of the image forming apparatus 100. For example, the controller 310 sets the clipping area CA as an area including the two sheet feed units 37, among the four units (the first to the fourth sheet feed units 37A to 37D), including the second sheet feed unit 37B including the sound collection target position FP and another one of the sheet feed units (the first sheet feed unit 37A for example). As described above, the image processing system 1 sets the clipping area CA based on the outlines of at least two units, and displays the partial image PI, clipped from the main body image MA, on the display 206. This configuration can provide an image the user can easily recognize which part of the image forming apparatus 100 is indicated.

The controller 310 changes the display mode of the partial image PI to a wireframe display mode with which the two sheet feed units are represented by a wireframes formed of lines. The controller 310 causes the transmitter 317 to transmit the partial image PI in the wireframe display mode to the mobile terminal 200. The controller 210 displays the partial image PI in the wireframe display mode on the display 206. The image processing system 1 may display the partial image PI and the apparatus image IM on the display 206 in an overlapping manner, to provide an image the user can easily determine Whether the images match. The following description is given assuming that the display mode of the partial image PI has been changed to the wireframe display mode.

The partial image PI in the wireframe display mode illustrated in FIG. 7 includes a first index m1 indicating the number of the first sheet feed unit 37A and a second index m2 indicating the number of the second sheet feed unit 37B, as well as the outlines of the first and the second sheet feed units 37A and 37B. The first index m1 and the second index m2 are hereinafter collectively referred to as an index m. The image processing system 1 displays the partial image PI including the outlines of the two sheet feed units 37 and their respective indices in on the display 206, so that the user can accurately recognize the part of the image forming apparatus 100 indicated by the partial image PI.

[Identification of Sound Passage Position and Setting of Sound Collection Target Position FP]

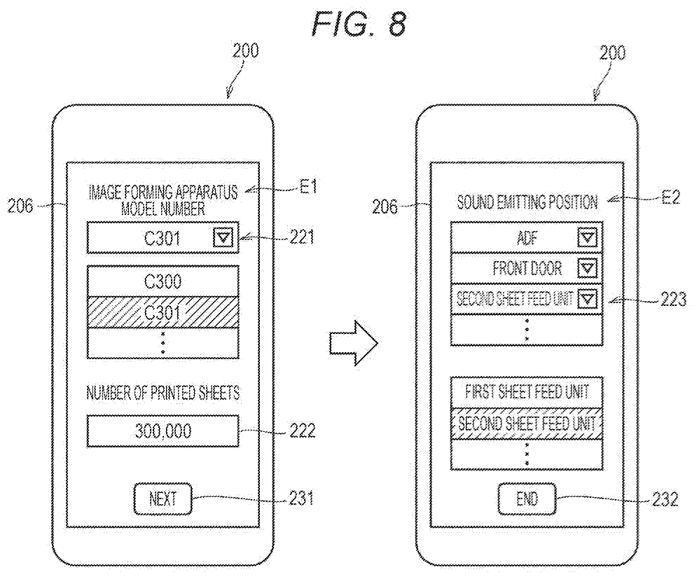

FIG. 8 is a diagram illustrating an example of a screen for inputting information such as the abnormal sound produced position and the like according to the present embodiment. Referring to FIG. 8, an application (not illustrated) for inputting an abnormal sound produced position of the image forming apparatus 100 and the like is installed to he on the display 206 of the mobile terminal 200. The controller 210 displays a first input screen E1 on the display 206 upon receiving an instruction for starting the application in response to an operation performed by the user. The first input screen E1 includes an identification field 221 for inputting identification information about the image forming apparatus 100, a number of printed sheets field 222 for inputting the number of printed sheets, and a next screen button 231 for transitioning to the next screen. The identification information is, for example, a model number indicating the model of the image forming apparatus 100.

The controller 210 displays the first input screen E1 on the display 206, and receives the model number (for example, C301) selected by the user by touching the identification field 221 on the operation part 205 using his or her finger. The controller 210 further receives the number of print sheets (for example, 300,000 sheets) input on the number of printed sheets field 222 by the user who has checked the number of print sheets, and an operation on the next screen button 231. The controller 210 displays a second input screen E2 on the display 206, upon receiving the operation on the next screen button 231. The controller 110 of the image forming apparatus 100 displays the number of printed sheets included in the number of printed sheets data 124 on the operation panel 106, upon receiving an instruction to display the number of printed sheets from the user. The user checks the number of printed sheets displayed on the operation panel 106.

The second input screen E2 includes a sound produced position field 223 for selecting a unit at an abnormal sound produced position of the image forming apparatus 100, and a completion button 232 for completing the processing of setting of a sound collection target position. The controller 210 receives the second sheet feed nit (second sheet feed unit 37B) selected on the sound produced position field 223 by the user through a touching operation on the touch panel of the operation part 205 using his or her finger. The controller 210 causes the transmitter 217 to transmit input information in response to the operation on the completion button 232 by the user. The input information thus transmitted is received by the receiver 327 of the server apparatus 300. The sound produced position field 223 is, for example, an field selected by the user who heard abnormal sound while printing by the image forming apparatus 100 is in progress.

FIG. 9 is a diagram illustrating the side surface 100b of the image forming apparatus 100 for describing the processing of identifying, a sound passage position on the main body of the image forming apparatus 100 and the processing of setting the sound collection target position FP according to the present embodiment. Referring to FIG. 9, with the input information, the controller 310 identifies a portion of the image forming apparatus 100 where the sound produced inside the image forming apparatus 100 passes through to be output to the outside. More specifically, with the input information from the mobile terminal 200 indicating that the sound produced position is the second sheet feed unit 373 on the second stage, the controller 310 identifies the portion of the image forming apparatus 100 through which the sound produced by the sheet feed roller 42B passes to be output to the outside. The portion of the image forming apparatus 100 is a portion set in advance for each unit. For example, when the sheet feed unit 37 is selected on the second input screen E2 of the mobile terminal 200 illustrated in FIG. 8 described above, a right portion set in advance on the right side is identified. Then, the right part identified as illustrated in FIG. 7 is set as the sound collection target position FP. As viewed from the front surface 100a of the image forming apparatus 100, consumable parts (for example, the sheet feed roller 42) in the sheet feed unit 37 are provided on the right side. Thus, a portion on the right side is set to be identified in advance. As described above, for each unit of the image forming, apparatus 100, a portion to he identified as the abnormal sound produced position is set in advance.

The controller 310 sets the identified portion as the sound collection target position FP. The sound collection target position FP is, for example, set to have a size corresponding to a circular range having a diameter of 15 cm, but the size and the shape of the range are not limited to these, and other sizes and shapes may be employed. The direction in which the sound produced inside the image forming apparatus 100 (for example, the sheet feed roller 42B in the second sheet feed unit 37B) is output to the outside is, for example, a direction indicated by an arrow AR1. The controller 310 recognizes the position of the microphone 209 as a position on an extension passing through the sound collection target position FP on the front surface 100a of the image forming apparatus 100 the direction indicated by the arrow AR1. A distance D from the sound collection target position FP to the microphone 209 is, for example, 1 m.

The controller 310 acquires the angle of view θ corresponding to the model of the mobile terminal 200 and the positions of the camera 208 and the microphone 209 from the mobile terminal data 334 in the storage 304.

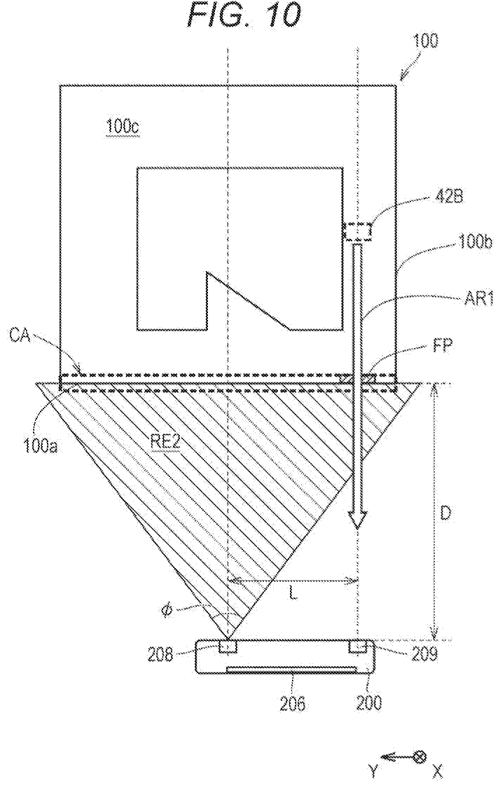

Then, the controller 310 determines the clipping area CA based on the distance W between the positions of microphone 209 and camera 208, an imaging range RE1 based on the angle of view θ of the camera 208, and the distance L between the positions of microphone 209 and camera 208 in FIG. 10 described later, and an imaging range RE2 based on the angle of view φ. The clipping area CA is an area clipped from the main body image MA to be the partial image PI. The angle of view θ is, for example, 84 degrees. The focal length of the camera 208 with an angle of view of 84 degrees is, for example, 24 mm.

FIG. 10 is a diagram illustrating an upper surface 100c of the image forming apparatus 100 for describing the processing of identifying a sound passage position o the main body of the image forming apparatus 100 and the processing of setting the sound collection target position FP according to the present embodiment. Referring to FIG. 10, the controller 310 recognizes the position of the microphone 209 as a position on the extension passing through the sound collection target position FP on the front surface 100a of the image forming apparatus 100 in the direction indicated by the arrow AR1, as described above with reference to FIG. 9. A distance D from the sound collection target position FP to the microphone 209 is, for example, 1 m.

The controller 310 acquires the angle of view θ and the angle of view φ corresponding to the model of the mobile terminal 200 and the distances L and W between the positions of the camera 208 and the microphone 209, from the mobile terminal data 334 in the storage 304. Then, the controller 310 determines the clipping area CA based on the imaging range RE1, based on the angle of view θ, the imaging range RE2 based on the angle of view φ, and the distances W and L. With the position of the microphone 209 with respect to the sound collection target position FP thus determined, the controller 310 determines the position of the camera 208 from the distance W and the distance L. With the position of the camera determined, the controller 310 determines the clipping area CA included in the imaging range RE1 based on the angle of view θ and the imaging range RE2 based on the angle of view φ. In this manner, the controller 310 determines the clipping area CA, and clips an image with the sound collection target position FP being a position on the extension from the position of the microphone 209 toward the image forming apparatus 100. Thus, the image processing system 1 can provide an image that allows the user to intuitively recognize the optimum position of the mobile terminal 200 for collecting the sound output from the inside of the image forming apparatus 100.

When the partial image PI is displayed on the display 206, the controller 210 of the mobile terminal 200 sets a display magnification of the apparatus image IM, displayed on the display 206 together with the partial image PI, to be a predetermined magnification (for example, 100%). Then, the controller 210 disables increase and reduction of the size of the apparatus image IM. More specifically, the controller 210 causes the touch panel, serving as the operation part 205, not to receive a pinch out operation of increasing the size of the apparatus image IM and a pinch in operation of reducing the size of the apparatus image IM, performed by the user using two of his or fingers in contact with the touch panel. Thus, the image processing system 1 can collect the sound output from the image forming apparatus 100 at a position corresponding to the partial image PI with the microphone 209, while preventing the size of the apparatus image IM from being changed by a user operation without fail.

Furthermore, the controller 210 of the mobile terminal 200 may disable a change in the display mode of the apparatus image IM due to a change in the orientation of the mobile terminal 200 between vertical and horizontal orientations, while the partial image PI is being displayed. The change in the orientation of the mobile terminal 200 is detected by, for example, an acceleration sensor (not illustrated) provided in the mobile terminal 200. The image processing system 1 can collect the sound output from the image forming apparatus 100 with the microphone 209 at a position where the apparatus image IM and the partial image PI match, while preventing the size of the apparatus image IM from being changed due to a change in the orientation of the mobile terminal.

FIG. 11 is a diagram illustrating how the partial image PI and the apparatus image IM are overlapped according to the present embodiment. Referring to FIG. 11, the controller 210 of the mobile terminal 200 displays the partial image PI and the apparatus image IM of the image forming apparatus 100 on a first screen E11 of the display 206. The partial image PI and the apparatus image IM do not match on the first screen E11. The position of the microphone 209 is not at a position on the extension from the sound collection target position FP, and is at a position deviated from the sound collection target position FP. The controller 210 does not start the sound collection with the microphone 209 due to the mismatch between the partial image PI and the apparatus image IM,

The controller 210 starts the sound collection with the microphone 209, when the partial image PI and the apparatus image IM are detected to match as illustrated in a second screen E12 due to the movement of the user holding the mobile terminal 200. When the partial image PI and the apparatus image IM match, the microphone 209 is positioned on the extension from the sound collection target position FP. In this manner, the image processing system 1 provides an image (partial image PI) that allows the user to intuitively recognize the optimum position for collecting the sound output from the inside of the image forming apparatus 100. Thus, the image processing system 1 can shorten the time required for the user to move to a position optimum for collecting the sound output from the inside of the image forming apparatus 100. Note that the sound collection target position FP is schematically illustrated in the drawing, and is illustrated in to be displayed while being overlapped with the image forming apparatus 100, the mobile terminal 200, or the like for the sake of description. In other words, in actual processing executed by the image processing system 1, the sound collection target position FP is not displayed on the image forming apparatus 100 or the mobile terminal 200. The same applies to the display of the following sound collection target positions FP.

The controller 210 starts the sound collection with the microphone 209 when at least the shapes of the partial image PI and the apparatus image IM match as a result of the partial image PI and the apparatus image IM being displayed on the display 206 in an overlapping manner. Thus, the image processing system 1 can swiftly start the sound collection once the partial image PI and the apparatus image IM match. The controller 210 may determine whether the partial image PI and the apparatus image IM match based on a parameter other than the shapes of the images, such as a color for example, or based oil the two parameters which are the shapes and the colors of the images.

[Structure of Control Performed with Image Processing System]

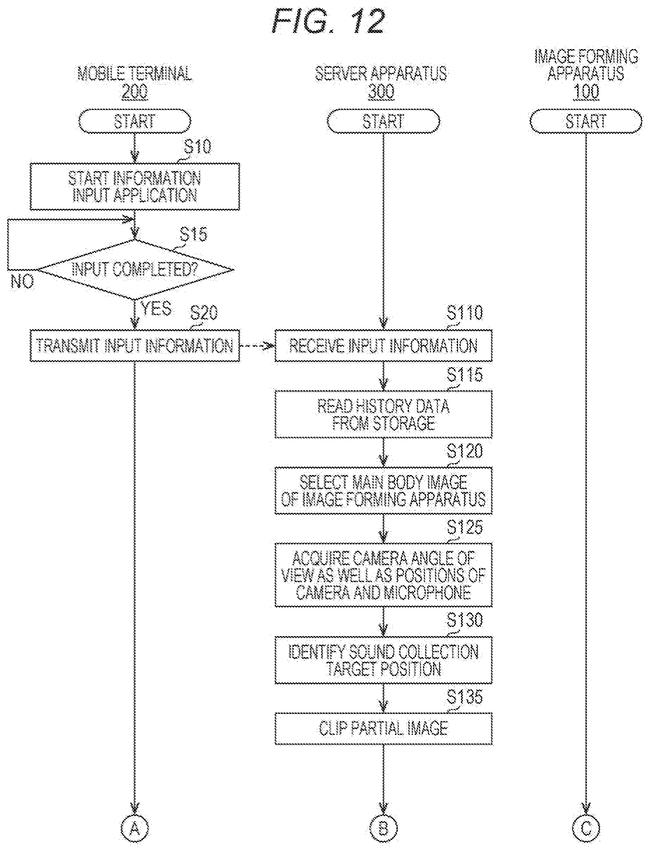

A structure of control performed with the image processing system 1 will be described with reference to FIGS. 12 to 14. FIGS. 12 to 14 are flowcharts illustrating a structure of control performed in the image forming apparatus 100, the mobile terminal 200, and the server apparatus 300 according to the present embodiment. In step S10, the controller 210 of the mobile terminal 200 starts an application for inputting failure information about the image forming apparatus 100 by a user operation, and displays one of the first input screen E1 and the second input screen E2 on the display 206.

In step S15, the controller 210 determines whether or not the input of the input information by the user has been completed, and the completion button 232 has been pressed by a user operation. When controller 210 determines that the input has been completed (YES in step S15), the control proceeds to step S20. Otherwise (NO in step S15), the controller 210 executes the processing of this step once in every predetermined period of time. Note that the controller 210 may terminate the processing of this flowchart when the condition fails to be satisfied with the processing of this step performed for a predetermined number of times.

In step S20, the controller 210 causes the transmitter 217 to transmit the input information to the server apparatus 300. The input information includes identification information about the image forming apparatus 100 (for example, the model number indicating the model of the image forming apparatus 100), the number of sheets printed by the image forming apparatus 100, and information about the produced position of abnormal sound output from the image forming apparatus 100. In addition, the controller 210 transmits identification information (for example, a model number indicating the model of the mobile terminal 200) about the mobile terminal including the controller 210 to the server apparatus 300 together with the input information. Hereinafter, the identification information about the image forming apparatus 100 is also referred to as first identification information, and identification information about the mobile terminal 200 is also referred to as second identification information. In response to the transmission of the input information, the controller 310 of the server apparatus 300 executes the control in step S110.

In step S110, the controller 310 receives the input information using the receiver 327, and the control proceeds to step S115. In this manner, the processing of the server apparatus 300 starts when the controller 310 of the server apparatus 300 receives the information input to the mobile terminal 200.

In step S115, the controller 310 reads the history data 344 associated with the image forming apparatus 100, in the history data 344 stored in the storage 304.

In step S120, the controller 310 selects a main body image corresponding to the model number of the image forming apparatus 100 in the main body image data 324 stored in the storage 304, and the control proceeds to step S125. The main body image is, for example, the main body image MA representing the front surface 100a of the image forming apparatus 100. Thus, the image processing system 1 can select an appropriate main body image corresponding to the target image forming apparatus 100.

In step S125, the controller 310 obtains the angle of view of the camera 208 corresponding to the model number of time mobile terminal 200 and the positions of the camera 208 and the microphone 209 in the mobile terminal data 334 stored in the storage 304.

In step S130, with the input information acquired from the mobile terminal, time controller 310 identifies a portion of the image forming apparatus 100 where the sound produced inside the image forming apparatus 100 passes through to be output to the outside. Then, the controller 310 sets the portion thus identified as the sound collection target position FP.

In step S135, the controller 310 selects the main body image in the main body image data 324 stored in the storage 304, based on the first identification information. Then, the controller 310 determines the clipping a CA based on the positions of the camera 208 and the microphone 209 of the mobile terminal 200, and clips the partial image PI including the sound collection target position FP.

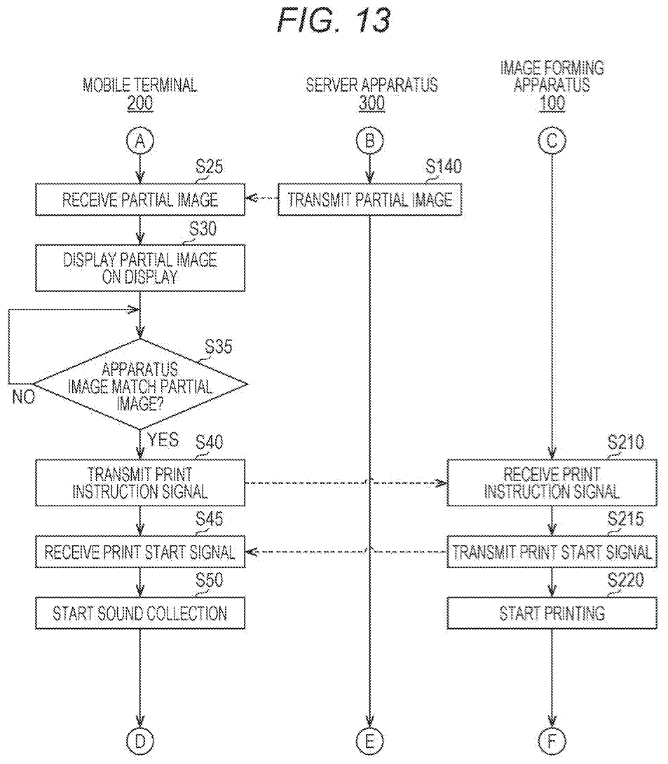

Next, referring to FIG. 13, in step S140, controller 310 causes transmitter 317 to transmit time partial image PI to the mobile terminal 200. In response to the transmission of the partial image PI, the controller 210 executes the control in step S25.

In step S25, the controller 210 receives the partial image PI using the receiver 227.

In step S30, the controller 210 causes the display 206 to display the partial image PI. The controller 210 starts the camera 208 when the partial image PI is displayed 206 on the display. The image processing system 1 can swiftly make the determination on whether the partial image PI and the apparatus image IM match with the camera 208 started at the timing when the partial image PI is displayed on the display 206.

In step S35, the controller 210 determines whether at least the shapes of the apparatus image IM based on the signal acquired by the camera 208 and the partial image PI match. When at least the shapes of the apparatus image IM and the partial image PI match (YES in step S35), the control by the controller 210 proceeds to step S40. Otherwise (NO in step S35), the controller 210 executes the processing of this step once in every predetermined period of time. Note that the controller 210 may terminate the processing of this flowchart when the condition fails to be satisfied with the processing of this step performed for a predetermined number of times.

In step S40, the controller 210 causes the transmitter 217 to transmit a print instruction signal to the image forming apparatus 100. In response to the transmission of the print instruction signal, the controller 110 of the image forming apparatus 100 executes the control in step S210.

In step S210, the controller 110 receives the pant instruction signal using the receiver 127.

In step S215, the controller 110 causes the transmitter 117 to transmit the print instruction signal to the mobile terminal 200.

In step S220, the controller 110 operates the scanner unit 20, the image forming unit 25, and the sheet feed unit 37 to start the printing.

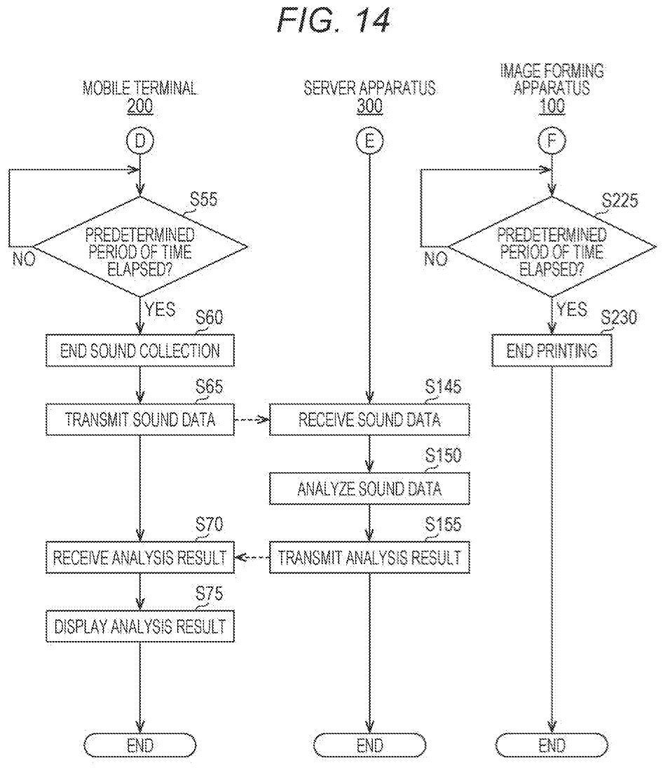

Referring to FIG. 14, the controller 110 determines whether a predetermined period of time has elapsed. The predetermined period of time is, for example, 30 seconds, arid the printing continues to be performed during this time. When the controller 110 determines that the predetermined period of time has elapsed (YES in step S225), the control proceeds to step S230. Otherwise (NO in step S225), the controller 110 continues the printing by image forming apparatus 100.

In step S230, the controller 110 ends the printing by the image forming apparatus 100.

Referring back to FIG. 13, in step S45, the controller 210 receives the print start signal using the receiver 227.

In step S50, the controller 210 starts the microphone 209 to collect the sound output while the image forming apparatus 100 is performing the printing. More specifically, when the two images (the apparatus image IM and the partial image PD displayed on the display 206 in an overlapping manner match, the controller 210 causes the microphone to starts the sound collection. In other words, with the sound collection target position FP being a position on the extension from the position of the microphone 209, the controller 210 causes the microphone 209 to start the sound collection.

In step S55, the controller 210 determines whether a predetermined, period of time has elapsed. The predetermined period of time is, for example, 30 seconds, and the sound collection by the microphone 209 continues to be performed during this time. When the controller 210 determines that the predetermined period of time has elapsed (YES in step S55), the control proceeds to step S60. Otherwise (NO in step S55), the controller 210 continues the sound collection by the microphone 209.

In step S60, the controller 210 ends the sound collection by the microphone 209.

In step S65, the controller 210 causes the transmitter 217 to transmit data about the sound collected (hereinafter, also referred to as “sound data”) to the server apparatus 300. The controller 310 executes the control in step S145 in response to the transmission of the sound data.

In step S145, the controller 310 receives the sound data using the receiver 327.

In step S150, the controller 310 analyzes the sound data. More specifically, the controller 310 determines the cause of the abnormal sound inside the image forming apparatus 100 based on the frequency and amplitude included in the sound data. For example, based on the information about the frequency and the amplitude, the controller 310 determines that the abnormal sound is caused by the sheet feed roller 42, which is one of the consumable parts.

In step S155, the controller 310 causes transmitter 317 to transmit the analysis result to the mobile terminal 200. The analysis result includes, for example, information indicating that the noise is caused by the sheet feed roller 42. The controller 210 executes the control in step S70 in response to the transmission of the analysis result.

In step S70, the controller 210 receives the analysis result using the receiver 227.

In step S75, the controller 210 displays the analysis result on the display 206. The image processing system 1 can accurately determine the cause of the abnormal sound output from the image forming apparatus 100.

### Second Embodiment

[Generation of Enlarged Partial Image]

In the processing described in the first embodiment, the cause of the abnormal sound can be identified with the analysis result obtained by the controller 310 performing the analysis based on the sound information. In a second embodiment, processing of clipping an enlarged partial image obtained by enlarging the partial image PI will be described. The processing is executed when the cause of the abnormal sound cannot be identified from the analysis result. The cause of the abnormal sound fails to be identified by factors such as a small amplitude in the sound data and noise in the sound data for example.

Hereinafter, the second embodiment according to the present disclosure will be described. An image processing system according to the second embodiment is implemented with hardware configurations of the image forming apparatus 100, the mobile terminal 200 and the server apparatus 300 being the same as those in the image processing system 1 according to the first embodiment. Therefore, the description on the hardware configurations will not be repeated.

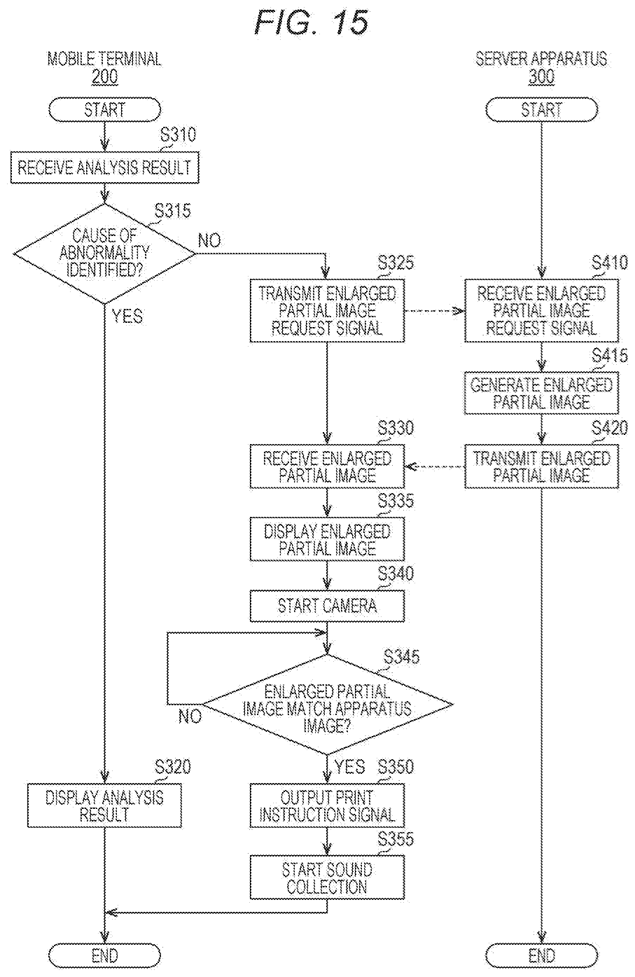

FIG. 15 is a flowchart illustrating a structure of control performed in the image forming apparatus 100, the mobile terminal 200, and the server apparatus 300 according to the second embodiment. Referring to FIG. 15, in step S310, controller 210 of the mobile terminal 200 receives the analysis result using the receiver 227.

In step S315, the controller 210 determines whether the cause of the abnormal sound has been successfully identified When the cause has been successfully identified (YES in step S315), the controller 210 causes the display 206 to display the analysis result including the name of the part or the like causing the abnormal sound. Otherwise (NO in step S315), the control performed by the controller 210 transitions to step S325.

In step S325, the controller 210 causes the transmitter 217 to transmit an enlarged partial image request signal to the server apparatus 300. The controller 310 of the server apparatus 300 executes control in step S410 in response to the transmission of the enlarged partial image request signal.

In step S410, the controller 310 receives the enlarged partial image request signal using the receiver 327.

In step S415, the controller 310 clips an enlarged partial image. The enlarged partial image is an image obtained by enlarging the partial image P1. The controller 310 generates, for example, an enlarged partial image by enlarging the partial image PI by 150%. The magnification of the enlargement by the controller 310 may be determined, for example, depending on a change in the distance D.

In step S420, the controller 310 causes transmitter 317 to transmit the enlarged partial image to the mobile terminal 200. The controller 210 executes control in step S330 in response to the transmission of the enlarged partial image.

In step S330, the controller 210 receives the enlarged partial image using the receiver 227.

In step S335, the controller 210 causes display 206 to display the enlarged partial image.

In step S340, the controller 210 starts the camera 208, and displays the apparatus image IM on the display 206.

In step S345, the controller 210 determines whether the enlarged partial image and apparatus image IM match. When the controller 210 determines that the enlarged partial image and apparatus image IM match (YES in step S345), the control proceeds to step S350. Otherwise (NO in step S345), the controller 210 executes the processing of this step once in every predetermined period of time. Note that the controller 210 may terminate the processing of this flowchart when the condition fails to be satisfied with the processing of this step performed for a predetermined number of times.

In step S350, the controller 210 causes the transmitter 217 to transmit a print instruction signal to the image forming apparatus 100.

In step S355, upon receiving a print start signal from the image forming apparatus 100, the controller 210 starts the microphone 209 to start the sound collection.

The user needs to bring the mobile terminal 200 closer to the image forming apparatus 100 so that the enlarged partial image matches the apparatus image IM in the processing in step S345 described above. More specifically, the position of the mobile terminal 200 needs to be closer to the image forming apparatus 100 than the position separated by the distance D (for example, 1 m) described with reference to FIG. 10. By bringing the mobile terminal 200 closer to the image forming apparatus 100 so that the enlarged partial image match the apparatus image IM in this manner, the distance between the microphone 209 and the sound collection target position FP decreases. The sound collected with the position of the microphone 209 of the controller 210 brought closer to the sound collection target position FP has a larger amplitude than that before the position is brought closer. The image processing system 1 displays the enlarged partial image on the display 206, so that the cause of the abnormal sound can be more reliably identified compared with that case where the partial image PI is displayed on the display 206.

In the above processing, the controller 310 of the server apparatus 300 may determine whether the cause of the abnormal sound has been successfully identified in step S315.

### Third Embodiment

[Change of Microphone Impression in Response Change in Size of Partial Image]in description of the first embodiment, the controller 210 disables the user operations to increase and reduce the size of the apparatus image IM. On the other hand, in a third embodiment, the user operations to increase and reduce the size of the apparatus image IM are enables, and the controller 210 changes the sensitivity of the microphone 209 in response to the user operation of increasing or reducing the apparatus image IM. A set value of the sensitivity of the microphone is stored, for example, in the storage 204.

The third embodiment according to the present disclosure will be described below. An image processing system according to the third embodiment is implemented with hardware configurations of the image forming apparatus 100, the mobile terminal 200 and the server apparatus 300 being the same as those in the image processing system 1 according to the first embodiment. Therefore, the description on the hardware configurations will not be repeated.

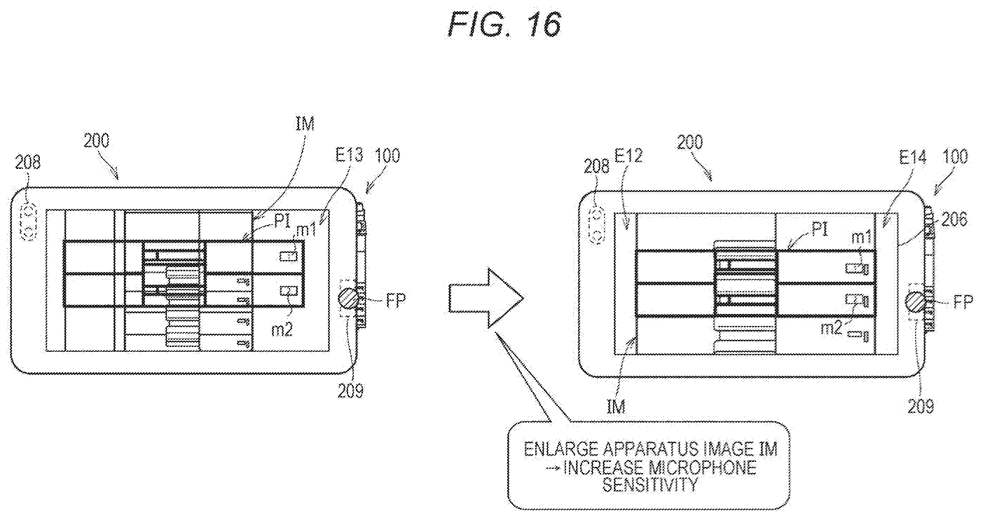

FIG. 16 is a diagram illustrating how the sensitivity of the microphone 209 is changed in response to the change in the size of the apparatus image IM according to the present embodiment. Referring to FIG. 16, as in a third screen E13 displayed on display 206 of mobile terminal 200, for example, when the camera 208 and the image forming apparatus 100 is separated from each other by the distance D (1 m for example) or more, the apparatus image IM displayed on the display 206 is smaller than the partial image PI.

As described above, when the apparatus image IM is smaller than the partial image PI, the size of the apparatus image IM displayed on the display 206 may be increased by the user operating the mobile terminal 200 approaching the image forming apparatus 100. The movement of the user thus required might be cumbersome for the user, or may take time until the optimum position is reached.

When the partial image PI is displayed as in a fourth screen E14 displayed on the display 206, the controller 210 changes the sensitivity of the microphone 209 in response to the change in the size of the apparatus image IM due to the user operation. For example, the user operation for changing the size of the apparatus image IM is any one of pinch out or pinch in performed by the user with two of his or her fingers in contact with the operation part 205 serving as the touch panel. The controller 210 increases the size of the apparatus image IM when the pinch out operation is detected. The controller 210 reduces the size of the apparatus image IM when the pinch in operation is detected.

When the apparatus image IM displayed on the display 206 in FIG. 16 is enlarged by a user operation, the controller 210 sets the sensitivity of the microphone 209 to be higher than that before the change. The sensitivity of the microphone 209 increases, for example, according to the enlargement magnification of the apparatus image IM. When the apparatus image IM is reduced by a user operation, the controller 210 sets the sensitivity of the microphone 209 to be lower than that before the change. As described above, the image processing system 1 changes the sensitivity of the microphone 209 according to the change in the size of the apparatus image IM due to the user operation. Thus, the apparatus image IM matching the partial image PI can be provided without requiring the user to move. Furthermore, the sound output from the image forming apparatus 100 can be reliably collected.

### Fourth Embodiment

[Displaying Partial Image on Different Screen]

In the description of the first embodiment, the controller 310 displays the partial image PI in the wireframe display mode on the display 206. On the other hand, in a fourth embodiment, the controller 310 transmits the partial image PI, which has been clipped from the main body image MA, from the transmitter 317 to the mobile terminal 200.

The fourth embodiment according to the present disclosure will be described below. An image processing system according to the fourth embodiment is implemented with hardware configurations of the image forming apparatus 100, the mobile terminal 200 and the server apparatus 300 being the same as those in the image processing system 1 according to the first embodiment. Therefore, the description on the hardware configurations will not be repeated.

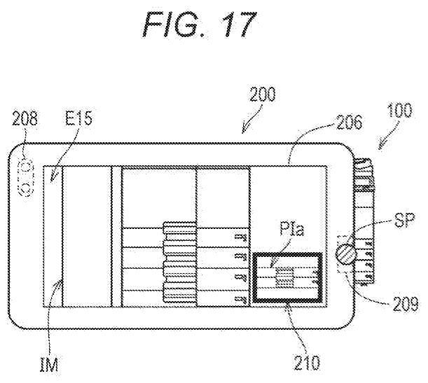

FIG. 17 is a diagram illustrating how a partial image PIa, clipped from the main body image MA, is displayed in a display area 210 of the display 206 of the mobile terminal 200 according to the present embodiment. The partial image PIa is a partial image before being changed to the wireframe display mode. Referring to FIG. 17, the controller 210 of the mobile terminal 200 that has received the partial image PIa from the server apparatus 300 using the receiver 227 displays the partial image PIa on the display 206. More specifically, the controller 210 displays partial image PIa in the area 210, in the display area of the display 206, which is smaller than the area where apparatus image IM is displayed. The controller 210 displays the partial image PIa in a relatively small area of the display 206, and displays the apparatus image IM and the partial image IPa on different screens.

Then, when the position of the microphone 209 reaches a position on the extension from the sound collection target position FP, the controller 210 issues a notification indicating that the optimum position for the sound collection has been reached, using characters and the like displayed on the display 206 or using sound emitted from a speaker (not illustrated). In this manner the image processing system 1 displays the apparatus image IM and the partial image PIa on different screens in the display 206. Thus, images that can be compared with each other by the user while moving to the optimum position for collecting sound output from the image forming apparatus 100 using the microphone 209.

### Fifth Embodiment

[Displaying Partial Image on Different Screen]

In the processing described in the second embodiment, the controller 310 clips the enlarged partial image when the cause of the abnormal sound cannot be identified from the analysis result. On the other hand, in a fifth embodiment, upon failing to identify the cause of the abnormal sound produced from the analysis result, the controller 310 clips the partial internal image including the sound collection target position FP from the main body image of the internal of the image forming apparatus 100.

The fifth embodiment according to the present disclosure will be described below. An image forming apparatus according to the fifth embodiment is implemented with hardware configurations of the image forming apparatus 100, the mobile terminal 200 and the server apparatus 300 being the same as those in the image processing system according to the first embodiment. Therefore, the description on the hardware configurations will not be repeated.

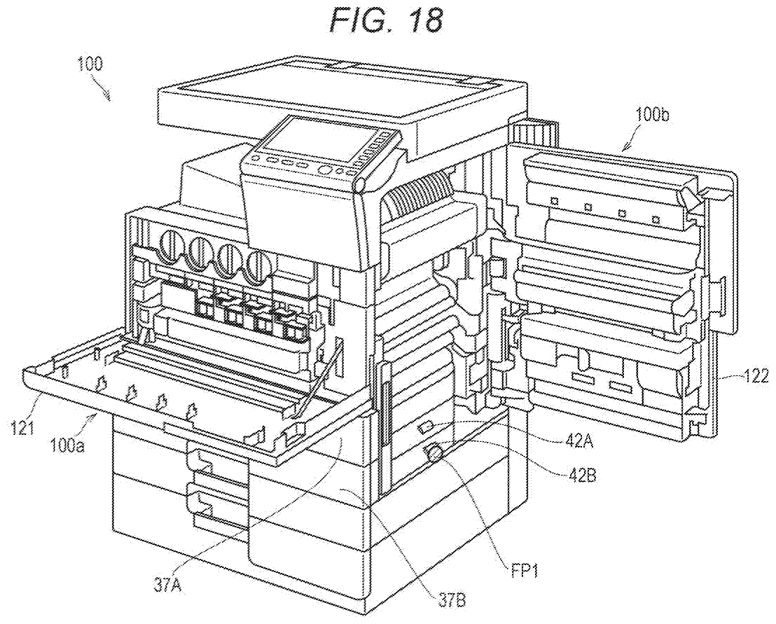

FIG. 18 illustrates a state of the image forming apparatus 100 according to the present embodiment with a front door 121 and a side door 122 open. When the controller 310 sets the position inside the side surface 100b in the image forming apparatus 100 as a sound collection target position FP1, the position FP1 corresponding to the sheet feed roller 42B provided inside the second sheet feed unit 379 for example. A partial image including the sound collection target position FP1 is clipped from the main body image in a state where the side door 122 on a side surface 100b is open. The main body image is an image representing the internal of the image forming apparatus 100 in the state where the side door 122 of the image forming apparatus 100 are open. The controller 310 selects a main body image representing the internal based on information transmitted from the mobile terminal 200. More specifically, the controller 210 receives additional information input by the user on the second input screen E2 displayed on the display 206. The additional information is information including that the sound produced position is the side surface 100b of the image forming apparatus 100 and that the side door 122 is open, when the sound produced position field 223 is selected. The controller 210 causes the transmitter 217 to transmit the additional information to the server apparatus 300.

The controller 310 receives the transmitted additional information using the receiver 327, reads the main body image indicating the inside of the side surface 100b of the image forming apparatus 100, and clips a partial image including the sound collection target position FP1 from the internal main body image based on the clipping area. With this configuration, the image processing system 1 can collect sound in a state with no shielding object such as the side door, so that the sound collection can be performed with a higher efficiency.

<Modification>

In the above description when the controller 310 of the server apparatus 300 identifies the portion of the image forming apparatus 100 through which the sound produced inside the image forming apparatus 100 passes to be output to the outside, based on the information acquired from the mobile terminal 200. Then, the controller 310 sets the identified portion as the sound collection target position FP for collecting the sound by the microphone 209, and clips the partial image PI including the sound collection target position FP from the image representing the outer shape of the image forming apparatus 100 (the main body image data 324 stored in the storage 304). The controller 210 of the image forming apparatus 100 may execute the processing executed by the controller 310 as described above.

In the above description, when the controller 310 sets the sound collection target position FP, the application, in the mobile terminal 200, for inputting the failure information about the image forming apparatus 100 is used. Alternatively, when setting the sound collection target position FP, the controller 110 of the image forming apparatus 100 may collect sound produced in the image forming apparatus 100 with a microphone (not illustrated) provided in the image forming apparatus 100 and then set the sound collection target position.

In the above description, the main body image from which the partial image P1 is clipped by the controller 310 is the main body image MA mainly including the front surface 100a of the image forming apparatus 100. Alternatively, the main body image may be a main body image of the side surface 100b of the image forming apparatus 100. The main body image of the side surface 100b is included in the main body image data 324 in the storage 304. The controller 310 determines whether the main body image is to be the main body image MA of the front surface 100a or the main body image of the side surface 100b based on, for example, the number of printed sheets data 124 of the image forming apparatus 100 stored in the storage 104 and the history data 344 stored in the storage 304, in addition to the abnormal sound produced position acquired by the mobile terminal 200. When there are a plurality of candidates for the cause of abnormal sound produced, a consumable part whose exchanging timing is near of has already elapsed may be identified, based on the number of printed sheets and the like. Furthermore, based on the history data, consumable parts that have already been exchanged may be excluded from the candidates, so that only parts that have not been exchanged can remain as the candidates. Thus, the image processing system 1 can identify the cause of the abnormal sound with higher accuracy.

When the position of the part producing the abnormal sound inside the image forming apparatus 100 is closer to the side surface 100b than to the front surface 100a, the controller 310 sets the sound collection target position FP at a preset portion of a unit of the side surface 100b. The preset portion is a portion of the image forming apparatus 100 corresponding to a portion of the consumable part present in the target unit as described above. If there are a plurality of consumable parts in the unit and there are a plurality of portions of the image forming apparatus 100 corresponding to the positions of the consumable parts, the controller 310 selects a consumable part that may be producing abnormal sound based on the number of printed sheets arid the history data, and identify the portion of the image forming apparatus 100 corresponding to the position of the consumable part thus selected. Thus, the image processing system 1 collect sound output from the inside of the image forming apparatus 100 with improved efficiency.

In the above description, the portion of the image forming apparatus 100 to be set as the sound collection target position FP is preset for each unit of the image forming apparatus 100. On the other hand, the portion of the image forming apparatus 100 may be selected by a user operation on the second input screen E2 illustrated in FIG. 8. More specifically, after the user has selected the second sheet feed unit as the abnormal sound produced position on the second input screen E2, the controller 310 selects, for example, one of the plurality of portions as the abnormal sound produced portion on the second sheet feed unit. The controller 310 may set the sound collection target position FP based on the portion selected by the user. The plurality of portions to be selected is, for example, a “left portion”, a “center portion”, a “right portion”, and the like.

In the above description, the controller 210 displays the partial image PI on the display 206 and determines whether the apparatus image IM and the partial image PI match. Alternatively, the controller 210 may output a direction and a distance of movement required for the partial image PI and the apparatus image IM displayed in an overlapping maimer on the display 206 match, by means voice output from a speaker (not illustrated) of the mobile terminal 200.

In the above description, the angle of view of the camera 208 is obtained from the mobile terminal data 334 stored in the storage 304. Alternatively, the angle of view or the like of the camera 208 may be acquired from Exchangeable Image File Format (EXIF) data about an image captured by the camera 208.

Although embodiments of the present invention have been described and illustrated in detail, the disclosed embodiments are made for purposes of illustration mid example only and not limitation. The scope of the present invention should be interpreted by terms of the appended claims.

What is claimed is:

1. An image processing system comprising:
a mobile terminal; and
a server apparatus that communicates with the mobile terminal, wherein
the mobile terminal includes
a camera,
a display that displays an apparatus image of an image forming apparatus forming an image, based on a signal acquired by the camera,
a microphone that collects sound output from the image forming apparatus, and
a first hardware processor that controls the camera, the microphone and the display,
the server apparatus includes a second hardware processor that controls the server apparatus,
the second hardware processor performs
by acquiring information input to the mobile terminal, identifying a portion of the image forming apparatus through which sound produced in the image forming apparatus passes to be output to outside,
setting the portion identified as a sound collection target position at which sound is collected with the microphone, and
clipping, a partial image including the sound collection target position and representing an (maim of a part of the image forming apparatus, from a main body image generated in advance as an image representing an outer shape of the image forming apparatus, and
the display displays the partial image.

2. The image processing system according to claim 1, wherein the clipping the partial image includes clipping an image in which the sound collection target position is a position on an extension from a position of the microphone toward the image forming apparatus.

3. The image processing system according to claim 1, wherein the clipping the partial image includes clipping an image including two or more parts of the image foaming apparatus.

4. The image processing system according to claim 1, wherein the partial image includes a wireframe image.

5. The image processing system according to claim 1, wherein the setting the sound collection target position is based on number of printed sheets of the image forming apparatus and history data about maintenance for the image forming apparatus.

6. The image processing system according to claim 1, wherein the second hardware processor
determines, based on a frequency and an amplitude of sound collected with the microphone, a cause of the sound produced in the image forming apparatus.

7. The image processing system according to claim 6, wherein
the partial image includes an enlarged partial image obtained by enlarging a partial image generated in past, and
the clipping the partial image includes clipping the enlarged partial image when the determining the cause of the sound produced fails to identify the cause of the sound produced.

8. The image processing system according to claim 6, wherein
the main body image includes a main body internal image representing an internal structure of the image forming apparatus, and
the clipping the partial image includes clipping a partial internal image from the main body internal image when the determining the cause of the sound produced fails to identify the cause of the sound produced.

9. The image processing system according to claim 1, wherein
the sever apparatus further includes a storage,
the storage stores the main body image for each type of the image forming apparatus, and
the clipping the partial image includes clipping the partial image from the main body image corresponding to identification information for identifying the type of the image forming apparatus.

10. The image processing system according to claim 1, wherein the first hardware processor
starts collection of the sound by the microphone when at least shapes of the partial image and apparatus image displayed on the display in an overlapping manner match.

11. The image processing system according to claim 1, wherein the first hardware processor
starts the camera when the partial image is displayed on the display.

12. The image processing system according to claim 1, wherein the first hardware processor
displays the main body image in an area smaller than an area in which the apparatus image is displayed, in a display area of the display.

13. The image processing system according to claim 1, wherein the first hardware processor
changes sensitivity of the microphone in response to a change in a size of the apparatus image due to a user operation, while the partial image is displayed on the display.

14. The image processing system according to claim 1, wherein the first hardware processor
disables enlargement and reduction of the apparatus image by a user operation, while the partial image is displayed on the display.

15. The image processing system according to claim 1, wherein the first hardware processor
disables a change in a display mode of the apparatus image in response to a change in an orientation of the mobile terminal, while the partial image is displayed on the display.

16. An image processing system comprising:
a mobile terminal; and
an image forming apparatus that communicates with the mobile terminal and forms an image, wherein
the mobile terminal includes
a camera,
a display, and
microphone,
the image forming apparatus includes a hardware processor that controls the image forming apparatus,
the hardware processor performs
by acquiring information input to the mobile terminal, identifying a portion of the image forming apparatus through which sound produced in the image forming apparatus passes to be output to outside,
setting the portion identified as a sound collection target position at which sound is collected with the microphone, and
clipping a partial image including the sound collection target position and representing an outline of a part of the image forming apparatus, from a main body image generated in advance as an image representing an outer shape of the image forming apparatus, and
the display displays the partial image.

17. An image processing apparatus comprising:
a hardware processor that controls the image processing apparatus; and
a communicator that communicates with an image display apparatus including a microphone, wherein
the hardware processor performs
by acquiring information input to the image display apparatus, identifying a portion of the image processing apparatus through which sound produced in the image processing apparatus passes to be output to outside,
setting the portion identified as a sound collection target position at which sound is collected with the microphone, and
clipping a partial image including the sound collection target position and representing an outline of a part of the image processing apparatus, from a main body image generated in advance as an image representing an outer shape of the image processing apparatus, and
the communicator transmits the partial image to the image display apparatus.

18. The image processing apparatus according to claim 17, further comprising an image forming apparatus that forms an image.

19. An image display apparatus comprising:
a hardware processor that controls the image display apparatus;
a communicator that communicates with an image processing apparatus that processes an image;
a camera;
a display; and
a microphone, wherein
the communicator receives a partial image, which includes a sound collection target position at which the microphone collects sound and is an image representing an outline of a part of the image processing apparatus, from a main body image generated in advance as an image representing a outer shape of the image processing apparatus, and
the hardware processor performs
determining, based on a result of displaying the partial image and an apparatus image of the image processing apparatus on the display in an overlapping manner, whether a feature of the partial image and a feature of the apparatus image match, and
collecting sound produced from the image processing apparatus with the microphone when the features match.

20. A method for controlling an image processing system including a mobile terminal and a server apparatus that communicates with the mobile terminal, the method comprising:
displaying, by the mobile terminal including a camera, a microphone, and a display, an apparatus image of an image forming apparatus that forms an image, on the display;
collecting, by the mobile terminal, sound output from the image forming apparatus with the microphone;
by acquiring, by the server apparatus, information input to the mobile terminal, identifying a portion of the image forming apparatus through which sound produced in the image forming apparatus passes to be output to outside;
setting, by the server apparatus, the portion identified as a sound collection target position at which sound is collected with the microphone; and
clipping, by the server apparatus, a partial image including the sound collection target position and representing a outline of a part of the image forming apparatus, from a main body image generated in advance as an image representing an outer shape of the image forming apparatus, wherein
the displaying on the display includes displaying the partial image.

21. A non-transitory recording medium storing a computer readable control program for an image processing system including a mobile terminal and a server apparatus that communicates with the mobile terminal,
the control program causing a first hardware processor of the mobile terminal including a camera, a microphone, and a display to perform:
displaying an apparatus image of an image forming apparatus that forms an image, on the display, based on a signal acquired by the camera; and
collecting sound output from the image forming apparatus with the microphone,
the control program causing a second hardware processor of the server apparatus to perform:
by acquiring information input to the mobile terminal, identifying a portion of the image forming apparatus through which sound produced in the image forming apparatus passes to be output to outside;
setting the portion identified as a sound collection target position at which sound is collected with the microphone; and
clipping a partial image including the sound collection target position and representing an outline of a part of the image forming apparatus, from a main body image generated in advance as an image representing an outer shape of the image forming apparatus, wherein
the displaying on the display includes displaying the partial image.
